(19) United States
(12) Patent Application Publication
(10) Pub. No.: US 2020/0311496 A1
(43) Pub. Date: Oct. 1, 2020

(54) IMAGE PROCESSING APPARATUS AND NON-TRANSITORY COMPUTER READABLE MEDIUM STORING IMAGE PROCESSING PROGRAM

(71) Applicant: FUJI XEROX CO., LTD., Tokyo (JP)

(72) Inventor: Tsubasa KITAI, Kanagawa (JP)

(73) Assignee: FUJI XEROX CO., LTD., Tokyo (JP)

(21) Appl. No.: 16/521,521

(22) Filed: Jul. 24, 2019

(30) Foreign Application Priority Data
Mar. 25, 2019 (JP) 2019-056833

(51) Int. Cl. G06K 15/02

(52) U.S. Cl. CPC G06K 15/1848; G06K 2215/0057

(57) ABSTRACT

An image processing apparatus includes an acquisition unit acquiring content larger in size than a screen and scrolled on the screen as a moving image, an extraction unit extracting, from the moving image, a plurality of frame images corresponding to a plurality of divided images obtained by division of the content based on a size of the screen, and a generation unit generating a single still image by synthesizing the plurality of frame images extracted by the extraction unit.

### CROSS-REFERENCE TO RELATED APPLICATIONS

This application is based on and claims priority under 35 USC 119 from Japanese Patent Application No. 2019-056833 filed Mar. 25, 2019.

### BACKGROUND

### (i) Technical Field

The present invention relates to an image processing apparatus and a non-transitory computer readable medium storing an image processing program.

### (ii) Related Art

Known in the related art is a photo book data creation system creating a panoramic synthesis image wider than an individual image by extracting a plurality of images as moving image scenes from moving image data and synthesizing the images (see, for example, JP2013-038528A).

Also known in the related art is an information processing apparatus including first display means for cutting out at least a part of a first image as a second image, causing the cut second image to be displayed on a display unit, and performing scroll display by moving the position of the display frame of the second image on the first image in accordance with user input, first predetermined condition determination means for determining whether or not a first predetermined condition is satisfied, first acquisition means for acquiring a copy image obtained by copying of the second image displayed on the display unit in response to the first predetermined condition determination means determining that the first predetermined condition is satisfied, and second acquisition means for acquiring a copy image obtained by copying of a non-display range as a range other than the display range of the first image cut out as the second image (see, for example, JP2018-073143A).

### SUMMARY

Aspects of non-limiting embodiments of the present disclosure relate to an image processing apparatus with which content larger in size than a screen can be generated as a single still image with greater ease than in a case where the content is divided into a plurality of still images and generated.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

An image processing apparatus includes an acquisition unit acquiring content larger in size than a screen and scrolled on the screen as a moving image, an extraction unit extracting, from the moving image, a plurality of frame images corresponding to a plurality of divided images obtained by division of the content based on a size of the screen, and a generation unit generating a single still image by synthesizing the plurality of frame images extracted by the extraction unit.

### BRIEF DESCRIPTION OF THE DRAWINGS

Exemplary embodiment(s) of the present invention will be described in detail based on the following figures, wherein:

FIG. 1 is a front view illustrating content, a frame image, and a mobile terminal provided with an image processing apparatus according to the present embodiment;

FIG. 2 is a block diagram illustrating a hardware configuration of the image processing apparatus according to the present embodiment;

FIG. 3 is a block diagram illustrating a functional configuration of the image processing apparatus according to the present embodiment;

FIG. 4 is a front view illustrating a still image and a frame image processed with the image processing apparatus according to the present embodiment;

FIG. 5 is a front view illustrating the content, the still image, and the mobile terminal provided with the image processing apparatus according to the present embodiment;

FIG. 6 is a flowchart illustrating the action of the image processing apparatus according to a first embodiment;

FIG. 7 is a flowchart illustrating the action of the image processing apparatus according to a second embodiment;

FIG. 8 is a flowchart illustrating the action of the image processing apparatus according to a third embodiment; and

FIG. 9 is a front view illustrating a still image and a frame image processed with an image processing apparatus according to a comparative example.

### DETAILED DESCRIPTION

Hereinafter, embodiments according to the present invention will be described in detail based on accompanying drawings.

In the drawings, the same or equivalent components and parts are denoted by the same reference numerals.

In addition, the dimensional proportions in the drawings are exaggerated for convenience of description and may differ from actual proportions.

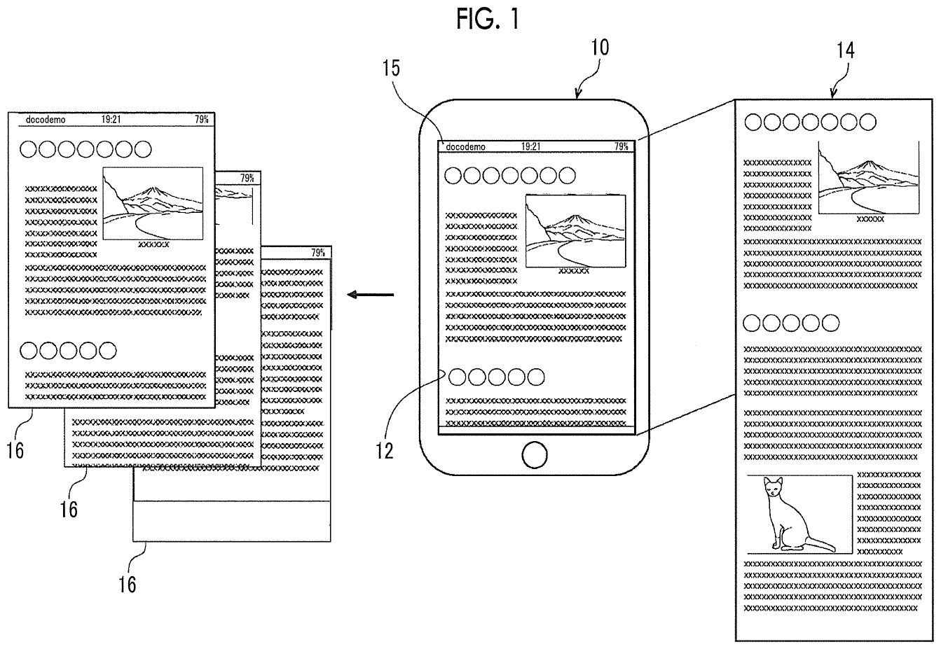

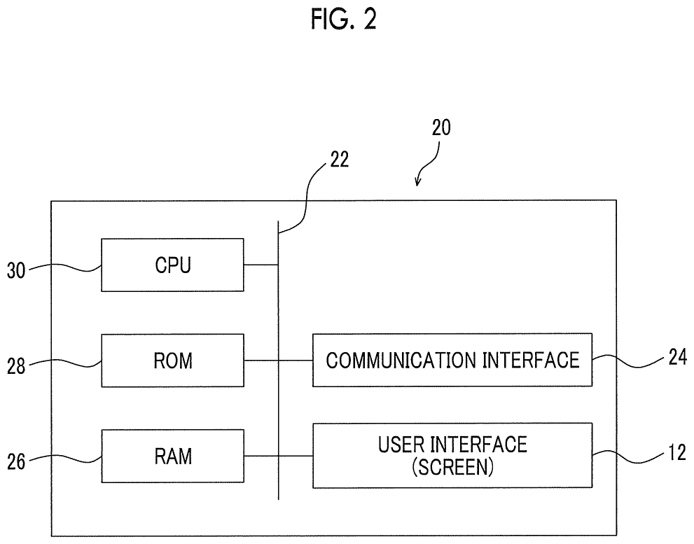

As illustrated in FIG. 1, an image processing apparatus (see FIG. 2) according to the present embodiment is incorporated in a mobile terminal 10 such as a smartphone, a tablet, and a laptop.

Image data is transmitted from the mobile terminal 10 to an image forming device (not illustrated) such as a multifunction printer by means of, for example, Wi-Fi (registered trademark) or Bluetooth (registered trademark), which will be described later. As a result, the image of the image data is printed onto a sheet of paper.

Here, “image” is content (such as a web page, a document, and a photograph) 14 larger in size than a screen 12 in the mobile terminal 10.

The mobile terminal 10 is not provided with a technical standard (such as an application corresponding to a print function) for printing the content 14 larger in size than the screen 12 as a single still image.

As illustrated in FIG. 2, the image processing apparatus 20 has a central processing unit (CPU) 30, a read only memory (ROM) 28, a random access memory (RAM) 26, a communication interface 24, and a user interface, that is, the screen 12 for scrolling.

The configurations are connected so as to be capable of communicating with each other via a bus 22.

The CPU 30, which is a central arithmetic processing unit, executes various programs and controls each part.

In other words, the CPU 30 reads a program from the ROM 28 and executes the program by using the RAM 26 as a work region.

The CPU 30 controls each of the above-described configurations and performs various types of arithmetic processing in accordance with the program recorded in the ROM 28.

In the present embodiment, a non-transitory computer readable medium storing an image processing program is stored in the ROM 28.

The CPU 30 is an example of a control unit.

The ROM 28 stores various programs and various data.

The RAM 26 temporarily stores a program or data as a work region.

The communication interface 24 is an interface for communicating with another device such as an image forming device. A standard such as Wi-Fi (registered trademark) and Bluetooth (registered trademark) is used for the communication interface 24.

In executing the non-transitory computer readable medium storing an image processing program, the image processing apparatus 20 realizes various functions by using the above-described hardware resources.

The functional configurations realized by the image processing apparatus 20 will be described below.

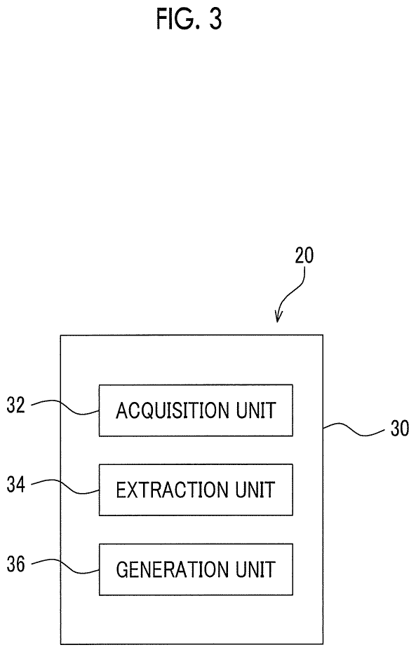

As illustrated in FIG. 3, the image processing apparatus 20 (CPU 30) has an acquisition unit 32, an extraction unit 34, and a generation unit 36 as the functional configurations.

Each functional configuration is realized by the CPU 30 reading and executing the non-transitory computer readable medium storing an image processing program stored in the ROM 28.

The acquisition unit 32 acquires the content 14 scrolled on the screen 12 as a moving image.

The extraction unit 34 extracts, from the moving image, a plurality of frame images 16 (see FIG. 1) corresponding to a plurality of divided images obtained by division of the content 14 based on the size of the screen 12.

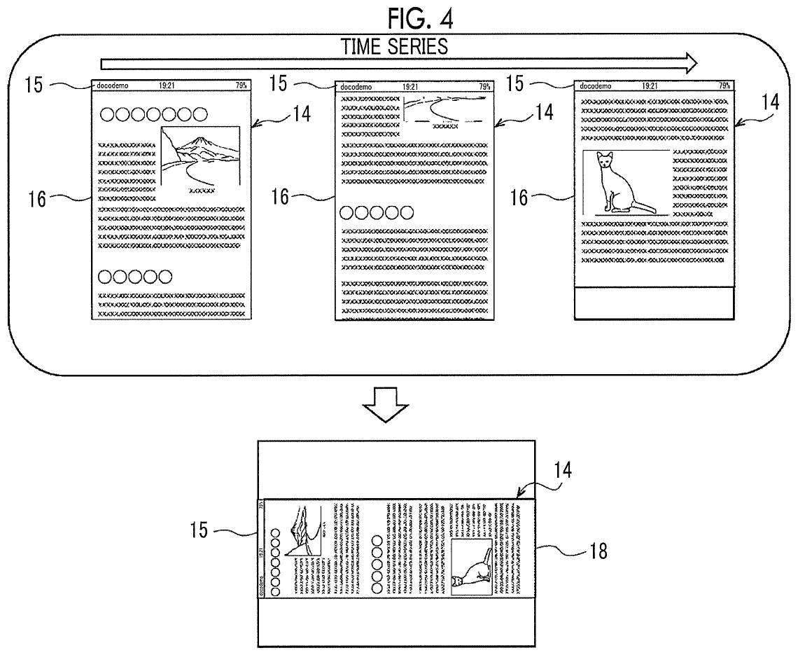

The generation unit 36 generates one still image 18 (see FIG. 4) by synthesizing the plurality of frame images 16 extracted by the extraction unit 34.

Specifically, the acquisition unit 32 acquires, as the moving image, the content 14 scrolled on the screen 12 as a result of user operation by using, for example, the function of “screen recording” that the mobile terminal 10 is equipped with.

At this time, the acquisition unit 32 acquires the speed of the scrolling, the direction of the scrolling, and the size of the screen 12 in the direction of the scrolling as well.

As illustrated in FIG. 4, the extraction unit 34 extracts the plurality of frame images 16 in time series by using the scrolling speed, the scrolling direction, and the size of the screen 12 in the scrolling direction.

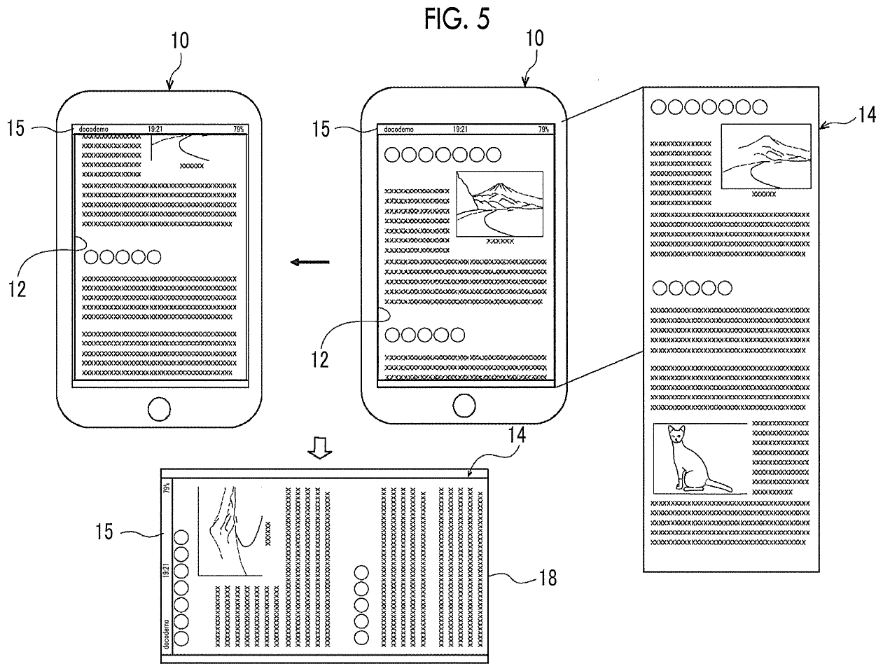

In addition, as illustrated in FIG. 5, the extraction unit 34 is capable of extracting the frame image 16 corresponding to a part of the content 14 displayed on the screen 12 as the final frame image 16 when a user has ended the scrolling operation halfway (including when the content 14 has been reversely scrolled and the scrolling has ended after scrolling to the end).

As illustrated in FIG. 4, the generation unit 36 generates the single still image 18 by superimposing (synthesizing) common parts in the plurality of frame images 16 in time series.

At this time, the generation unit 36 performs the synthesis by deleting an image not related to the content 14 from each of the plurality of frame images 16 in time series.

Here, “image not related to the content 14” is an image including at least one of a header 15 or a footer (not illustrated) displayed at the upper and lower ends of the midway frame image 16.

In addition, the generation unit 36 is capable of synthesizing the image including at least one of the header 15 or the footer (not illustrated) with at least one of the upper or lower ends of the single still image 18 (see FIG. 4).

In addition, the mobile terminal 10 is configured such that scrolling of the screen 12 is automatically possible instead of being manually possible by a user.

In other words, the mobile terminal 10 is configured such that the content 14 is automatically scrolled in a predetermined direction and at a predetermined speed under the control of the CPU 30.

In this case, the extraction unit 34 extracts the plurality of frame images 16 in time series by using the size of the screen 12 in the scrolling direction and the scrolling speed acquired by the acquisition unit 32.

In a case where the content 14 has a plurality of pages, the acquisition unit 32 acquires a moving image for each page, the extraction unit 34 extracts a plurality of the frame images 16 for each page, and the generation unit 36 generates one independent still image 18 for each page.

Also, the generation unit 36 is configured to generate the still image generated for each page as the single still image 18 combined in one page.

The action of each embodiment in the image processing apparatus 20 configured as described above will be described below.

The CPU 30 reads the non-transitory computer readable medium storing an image processing program from the ROM 28, develops the non-transitory computer readable medium storing an image processing program in the RAM 26, and executes the non-transitory computer readable medium storing an image processing program. Automatically performed as a result is image processing in which the content 14 larger in size than the screen 12 is turned into the single still image 18.

### COMPARATIVE EXAMPLE

A comparative example will be described first.

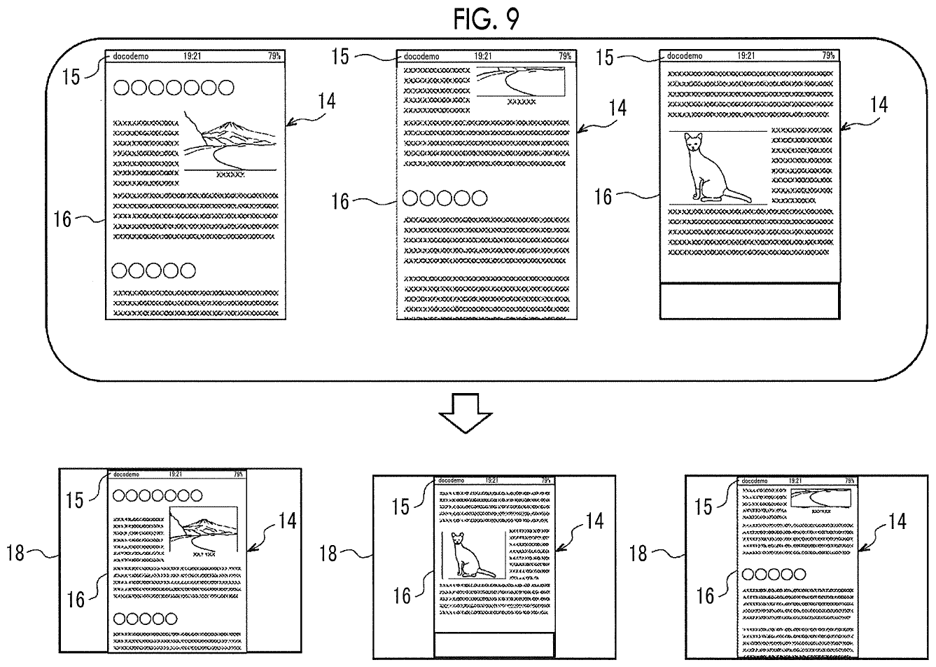

In a case where the content 14 larger in size than the screen 12 and displayed by scrolling on the screen 12 of the mobile terminal 10 not having an application or the like corresponding to a print function is completely printed, the frame image 16 displayed on the screen 12 is photographed for each scrolling by means of the screenshot photographing function provided as standard in the operation system (OS) of the mobile terminal 10 and the still image 18 is printed for each of the frame images 16 as illustrated in FIG. 9.

In other words, the content 14 is divided into a plurality of sheets (three sheets in the illustrated example) and printed.

Accordingly, a problem arises such as partial omission of the content 14, partial duplication of the content 14, and a changed order of the content 14.

In addition, the header 15 and the footer are also printed for each printed frame image 16, and thus a problem arises in the form of a region of needless printing at the upper and lower ends of the sheet.

In other words, the printing space at the upper and lower ends of the sheet is wasted.

Such a problem is addressed in the present embodiment.

This will be described below.

### First Embodiment

A first embodiment will be described first.

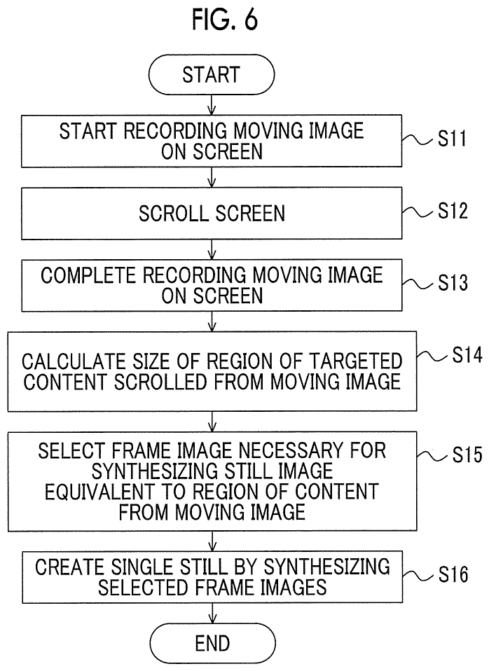

As illustrated in FIG. 6, “image recording” of the mobile terminal 10 is started so that a moving image on the screen 12 is recorded (Step S11).

Then, the screen 12 on which the target content 14 is displayed is scrolled manually by a user (Step S12).

Once the scrolling of the screen 12 is completed, “image recording” is stopped (Step S13).

As a result, the acquisition unit 32 acquires a moving image.

In addition, the acquisition unit 32 calculates the size of the scrolled content 14 (size of the region from the upper end to the lower end of the content 14) from the acquired moving image (Step S14).

Then, the extraction unit 34 selects (extracts) the plurality of frame images 16 necessary for synthesizing (creating) the still image 18 equivalent to the region of the content 14 from the moving image acquired by the acquisition unit 32 (Step S15).

Once the frame images 16 are selected in this manner, the generation unit 36 creates the single still image 18 by synthesizing common parts in the selected frame images 16 and deleting an image not related to the content 14 (Step S16).

As a result, the entire content 14 is more easily printed (or printable) as the single still image 18 than in a case where the content 14 is divided and printed into a plurality of still images even with the mobile terminal 10 not provided with a technical standard for printing the content 14 larger in size than the screen 12 as a single still image (see FIG. 4).

Although the first embodiment has been described above, there is an advantage that the apparatus configuration of the image processing apparatus 20 is simplified, as compared with a case where the acquisition unit 32 acquires the automatically scrolled content 14 (screen 12) as a moving image, as the acquisition unit 32 acquires the manually scrolled content 14 (screen 12) as a moving image.

In addition, the extraction unit 34 extracts the frame images 16 by using the scrolling speed, the scrolling direction, and the size of the screen 12 in the scrolling direction even though the content 14 (screen 12) is manually scrolled.

Accordingly, the content 14 is printed without partial omission or duplication.

In addition, as the acquisition unit 32 acquires the automatically scrolled content 14 (screen 12) as a moving image, there is an advantage that the moving image is acquired with greater ease than in a case where the acquisition unit 32 acquires the manually scrolled content 14 (screen 12) as a moving image.

When the content 14 (screen 12) is automatically scrolled, the extraction unit 34 extracts the plurality of frame images 16 by using the size of the screen 12 in the scrolling direction and the scrolling speed.

Accordingly, the content 14 is printed without partial omission or duplication.

In a case where the content 14 is automatically scrolled, the screen 12 is scrolled at a constant speed. Accordingly, even though the content 14 has a blank part, there is no possibility of a change in the length of the blank part.

However, in a case where the content 14 is manually scrolled, it is difficult to scroll the screen 12 at a constant speed, and thus the presence of a blank part in the content 14 may lead to a change in the length of the blank part.

As described above, the generation unit 36 performs the synthesis by deleting, from each of the plurality of frame images 16, an image not related to the content 14, that is, an image including at least one of the header 15 or the footer displayed at the upper and lower ends of the screen 12.

Accordingly, needless printing of the header 15 and the footer (unnecessary regions) in the single still image 18 is prevented as compared with a case where the header 15 and the footer not related to the content 14 in each of the plurality of frame images 16 are synthesized as they are.

The generation unit 36 is capable of synthesizing the image including at least one of the header 15 or the footer with the single still image 18, and thus it is possible to print only one header 15 and/or the footer in the single still image 18 (see FIG. 4).

### Second Embodiment

Next, a second embodiment will be described.

Description of actions common to the first and second embodiments will be appropriately omitted below.

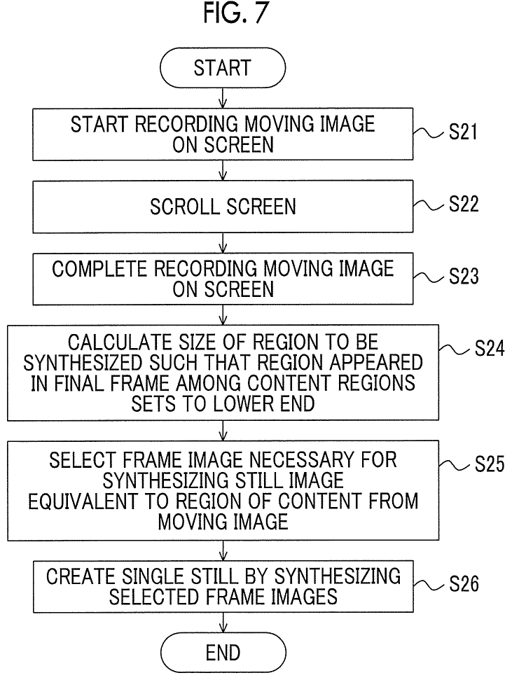

As illustrated in FIG. 7, “image recording” of the mobile terminal 10 is started so that a moving image on the screen 12 is recorded (Step S21).

Then, the screen 12 on which the target content 14 is displayed is scrolled manually by a user (Step S22).

Once the scrolling of the screen 12 is completed, “image recording” is stopped (Step S23).

As a result, the acquisition unit 32 acquires a moving image.

Here, when it is desired to set the lower end of the region (final frame) appearing as the final frame image 16 of the moving image in the region of the content 14 as the lower end (end) of the content 14 (when it is desired to set a specific position part above the actual lower end of the content 14 as the end), “image recording” is stopped up to the lower end.

As a result, the acquisition unit 32 acquires the region up to the lower end as the region of the content 14 for synthesis of the still image 18.

In addition, the acquisition unit 32 calculates the size of the scrolled content 14 (size of the region from the upper end of the content 14 to the lower end determined as described above) from the acquired moving image (Step S24).

Then, the extraction unit 34 selects (extracts) the plurality of frame images 16 necessary for synthesizing (creating) the still image 18 equivalent to the region of the content 14 from the moving image acquired by the acquisition unit 32 (Step S25).

Once the frame images 16 are selected in this manner, the generation unit 36 creates the single still image 18 by synthesizing common parts in the selected frame images 16 and deleting an image not related to the content 14 (Step S26).

As a result, only the necessary part of the content 14 is printed (or printable) as the single still image 18 (see FIG. 5).

Although the second embodiment has been described above, the extraction unit 34 extracts, as the final frame image 16, the frame image 16 corresponding to a part of the content 14 displayed on the screen 12 at the completion of the user scrolling operation.

Accordingly, the region printed as the single still image 18 can be set in any manner by a user and is not the entire content 14.

In other words, according to the second embodiment, there is an advantage that only a part of the content 14 desired by a user is printable.

### Third Embodiment

A third embodiment will be described below.

Description of actions common to the first and third embodiments will be appropriately omitted below.

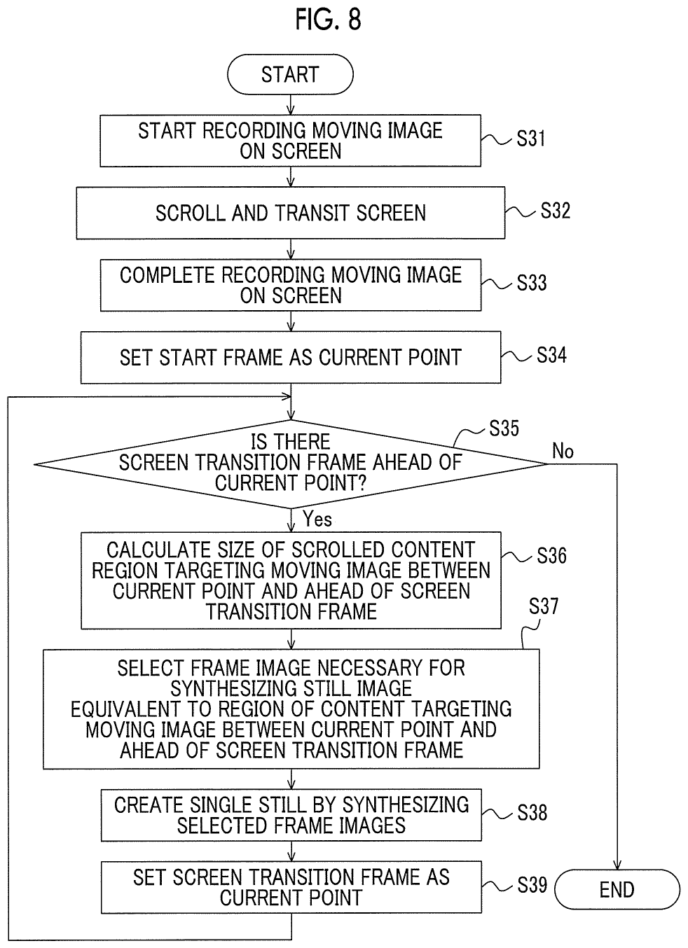

As illustrated in FIG. 8, “image recording” of the mobile terminal 10 is started so that a moving image on the screen 12 is recorded (Step S31).

Then, the screen 12 on which the target content 14 is displayed is scrolled manually by a user and then, in a case where there is another target content 14, the link to the next content 14 is pressed for display of the content 14 (transition to the additional content 14) and the screen 12 on which the additional content 14 is displayed is scrolled (Step S32).

This is repeated until the end of the plurality of contents 14.

Then, “image recording” is stopped once the scrolling of the screen 12 displaying the final content 14 finishes (Step S33).

As a result, the acquisition unit 32 acquires a moving image.

Subsequently, the processing returns to the first content 14 and the start frame is set as the current point (Step S34).

Next, it is determined whether or not there is the content 14 (screen transition frame) transitioned ahead of the current point (Step S35).

The presence or absence of the transitioned content 14 is determined by whether or not the link to the next content 14 is pressed.

In the case of absence of the screen transition frame, the single still image 18 is created by a process similar to the first embodiment or the second embodiment.

In the case of presence of the screen transition frame, the acquisition unit 32 calculates the size (region) of the scrolled content 14, targeting the moving image between the current point and ahead of the screen transition frame (Step S36).

Then, the extraction unit 34 selects (extracts) the plurality of frame images 16 necessary for synthesizing (creating) the still image 18 equivalent to the region of the content 14, targeting the moving image between the current point and ahead of the screen transition frame (Step S37).

Once the frame images 16 are selected in this manner, the generation unit 36 creates the single still image 18 by synthesizing common parts in the selected frame images 16 and deleting an image not related to the content 14 (Step S38).

Then, the screen transition frame is set as the current point (Step S39).

Subsequently, the processing returns to Step S35 and Steps S35 to S39 are repeatedly executed until the final content 14.

As a result, each of the plurality of contents 14 is printed (or printable) as one independent still image 18.

The plurality of contents 14 may be printed together as one independent still image 18.

Although the third embodiment has been described above, in a case where the content 14 has a plurality of pages, the acquisition unit 32 acquires the moving image for each page, the extraction unit 34 extracts the plurality of frame images 16 for each page, and the generation unit 36 generates the single still image 18 by synthesizing the still image generated for each page.

Accordingly, the content 14 having a plurality of pages is printed as one independent still image 18 for each page.

In addition, the generation unit 36 is capable of selectively generating the content 14 having a plurality of pages together as the single still image 18 and, in this case, printing is performed as the single still image 18 collected in one page.

Although the image processing apparatus 20 according to the present embodiment has been described above, the image processing apparatus 20 according to the present embodiment is not limited to the above embodiment and various improvements or modifications are possible without departing from the scope of the present invention.

For example, the direction of the scrolling is not limited to the vertical direction that is the longitudinal direction of the screen 12 and the direction of the scrolling may be the lateral direction that is a direction orthogonal to the longitudinal direction of the screen 12.

The same as the above applies to this case as well.

The image processing apparatus 20 according to the present embodiment is not limited to the configuration incorporated in the mobile terminal 10 and the image processing apparatus 20 may be incorporated in an image forming device such as a multifunction printer (not illustrated).

Further, the image processing apparatus 20 according to the present embodiment may be distributed and incorporated in the mobile terminal 10 and the image forming device.

For example, the acquisition unit 32 and the extraction unit 34 may be incorporated in the mobile terminal 10 with the generation unit 36 incorporated in the image forming device.

Although the generation unit 36 generates the single still image 18 by superimposing (synthesizing) common parts in plurality of frame images 16 in time series according to the description of the above embodiment, the present invention is not limited to this aspect.

It is a matter of course that the generation unit 36 generates the single still image 18 by disposing each frame image 16 in order in the case of absence of the common parts in the plurality of frame images 16 in time series (in the case of separation without omission).

The processing executed by the CPU 30 reading software (program) in the above-described embodiment may be executed by various processors other than the CPU 30.

Examples of the processors in this case include a programmable logic device (PLD) allowing a post-manufacturing change in circuit configuration such as a field-programmable gate array (FPGA) and a dedicated electric circuit as a processor having a circuit configuration of dedicated design in order to execute specific processing such as an application specific integrated circuit (ASIC).

The image processing may be executed with one of the various processors or a combination of two or more processors of the same or different types (such as a plurality of FPGAs and a CPU-FPGA combination).

In addition and more specifically, the hardware structure of the various processors is an electric circuit in which a circuit element such as a semiconductor device is combined.

Although the non-transitory computer readable medium storing an image processing program is stored (installed) in advance in the ROM 28 according to the description of each embodiment, the present invention is not limited thereto.

The non-transitory computer readable medium storing an image processing program may be provided in the form of being recorded in a recording medium such as a compact disk read only memory (CD-ROM), a digital versatile disk read only memory (DVD-ROM), and a universal serial bus (USB) memory.

In addition, the non-transitory computer readable medium storing an image processing program may be downloaded from an external device via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an acquisition unit acquiring content larger in size than a screen and scrolled on the screen as a moving image;
an extraction unit extracting, from the moving image, a plurality of frame images corresponding to a plurality of divided images obtained by division of the content based on a size of the screen; and
a generation unit generating a single still image by synthesizing the plurality of frame images extracted by the extraction unit.

2. The image processing apparatus according to claim 1, wherein the acquisition unit acquires the content scrolled by an operation of a user as a moving image.

3. The image processing apparatus according to claim 2, wherein
the acquisition unit acquires a speed of the scrolling, a direction of the scrolling, and a size of the screen in the direction of the scrolling, and
the extraction unit extracts the plurality of frame images by using the speed of the scrolling, the direction of the scrolling, and the size of the screen in the direction of the scrolling.

4. The image processing apparatus according to claim 2, wherein the extraction unit extracts, as a final frame image, a frame image corresponding to a part of the content displayed on the screen when the user finishes a scrolling operation.

5. The image processing apparatus according to claim 3, wherein the extraction unit extracts, as a final frame image, a frame image corresponding to a part of the content displayed on the screen when the user finishes a scrolling operation.

6. The image processing apparatus according to claim 1, further comprising:
a control unit performing control such that the content is automatically scrolled in a predetermined direction and at a predetermined speed.

7. The image processing apparatus according to claim 6, wherein the extraction unit extracts the plurality of frame images by using a speed of the scrolling and a size of the screen in a direction of the scrolling.

8. The image processing apparatus according to claim 1, wherein the generation unit performs synthesis by deleting an image not related to the content from each of the plurality of frame images.

9. The image processing apparatus according to claim 2, wherein the generation unit performs synthesis by deleting an image not related to the content from each of the plurality of frame images.

10. The image processing apparatus according to claim 3, wherein the generation unit performs synthesis by deleting an image not related to the content from each of the plurality of frame images.

11. The image processing apparatus according to claim 4, wherein the generation unit performs synthesis by deleting an image not related to the content from each of the plurality of frame images.

12. The image processing apparatus according to claim 5, wherein the generation unit performs synthesis by deleting an image not related to the content from each of the plurality of frame images.

13. The image processing apparatus according to claim 6, wherein the generation unit performs synthesis by deleting an image not related to the content from each of the plurality of frame images.

14. The image processing apparatus according to claim 7, wherein the generation unit performs synthesis by deleting an image not related to the content from each of the plurality of frame images.

15. The image processing apparatus according to claim 8, wherein the image not related to the content is an image including at least one of a header or a footer displayed at an end of the screen.

16. The image processing apparatus according to claim 9, wherein the image not related to the content is an image including at least one of a header or a footer displayed at an end of the screen.

17. The image processing apparatus according to claim 15, wherein the generation unit synthesizes an image including at least one of the header or the footer with the single still image.

18. The image processing apparatus according to claim 1, wherein, in a case where the content has a plurality of pages, the acquisition unit acquires the moving image for each of the pages, the extraction unit extracts the plurality of frame images for each of the pages, and the generation unit generates the single still image for each of the pages.

19. The image processing apparatus according to claim 18, wherein the generation unit generates the single still image by synthesizing the still image generated for each of the pages.

20. A non-transitory computer readable medium storing an image processing program for causing a computer to function as each unit of the image processing apparatus according to claim 1.
